(19) United States
(12) Patent Application Publication
(10) Pub. No.: US 2002/0042742 A1
(43) Pub. Date: Apr. 11, 2002

(54) Customer award and incentive system

(76) Inventors: Eiland Glover, Marietta, GA (US); Stuart R. Hogue, San Francisco, CA (US)

Correspondence Address: David L. Alberti, GRAY CARY WARE & FREIDENRICH, Attn: Patent Group, 1755 Embarcadero Road, Palo Alto, CA, 94303-3340, US

(21) Appl. No.: 09/938,950

(22) Filed: Aug. 23, 2001

Related U.S. Application Data
(60) Provisional application No. 60/227,011, filed on Aug. 23, 2000.

(30) Foreign Application Priority Data
Jul. 20, 2000 (US) PCT/US00/19730

(51) Int. Cl. G06F 17/60

(52) U.S. Cl. 705/14

(57) ABSTRACT

A system and method of rewarding customers is provided. Reward incentives in the form of equity in the seller are allocated to customers' accounts based on their purchasing activities. Purchase order records are periodically processed. Processing includes verification that requested equities are, available. It further includes aggregating the equity awards into larger lots that are then purchased in one or more buy transactions. The larger sized lots are then divided among the customer accounts from which the equity awards were taken. In this way orders may be processed without incurring relatively large transaction costs while allowing distribution of fractional amounts of equity shares. The method and apparatus of the present invention may be applied in particular in the context of an electronic commerce system.

### PRIORITY

This application claims the benefit of U.S. Provisional Application No. 60/227,011 filed Aug. 23, 2000, which provisional application is hereby incorporated by reference in its entirety.

### CROSS-REFERENCE TO RELATED APPLICATIONS

This application relates to following commonly assigned applications: U.S. Provisional Application No. 60/144,630, filed Jul. 20, 1999; U.S. Provisional Application No. 60/159,553, filed Oct. 15, 1999; U.S. Provisional Application No. 60/164,752 filed Nov. 12, 1999; and International Application No. PCT/US00/19730 filed Jul. 20, 2000. The respective disclosures of these applications are hereby incorporated by reference as if fully set forth herein.

### FIELD OF THE INVENTION

The present invention is directed generally to a customer incentive method and system for generating customer incentives and for rewarding customers with equity.

### BACKGROUND OF THE INVENTION

There is a continuing need for an efficient system and method for providing a customer incentive program that includes awarding an equity interest in the seller to the customer based on the customer engaging in particular purchasing activities.

As shown in FIG. 1, recently a customer reward system has been proposed in International Application No. PCT/US00/19730, incorporated herein by reference. The proposed system includes a seller's controller 20, a customer interface 30, and a seller's agent 40. Each interface 30, 40 may be connected via a network, such as the Internet or by other means. The connection may be made over or using dedicated data lines, cellular, PCs, microwave, or satellite networks or like networks. The seller's agent terminal 40 and customer interface 30 provide input and output gateways for communications with the central controller 20.

Such an architecture enables the system to post an activity from a customer, such as a purchase of the seller's goods or services. It allows the seller or its agent to give an incentive proportional to the value of the activity and gives the customer a piece of the seller's or its agent's economic future as a reward. The system may be internally administered by the seller or by a third party, bank or transfer agent.

A different customer reward system is disclosed in U.S. Pat. No. 5,970,480, which is also incorporated herein by reference in its entirety.

However, a problem that continues to be observed with customer reward systems is that rewarding customers with equity in the seller may carry with it high transaction costs because the rewards themselves may consist of many small lots of the seller's stock. Accordingly, there is a need for a more efficient system and method for accomplishing this.

### SUMMARY OF THE INVENTION

The present invention provides a system and method in which equity is awarded to customers. According to one aspect of the invention, customer criteria are tracked to evaluate and categorize customers so that the merchants can identify the customers who are the most profitable, those most likely to migrate into the “most profitable” group, and the customers who are the least profitable. Criteria for any given customer include various factors: the level of equity investment in a particular merchant; the number and frequency of customer transactions; and the correlation between customer equity investments and customer purchase activity decisions. This aspect of the invention facilitates the evaluation and confirmation of customer loyalty.

According to another aspect of the invention, various incentives are provided to target, enroll and maintain preferred customers. Enrollment incentives may include an initial award of equity in a particular company upon account enrollment, which award may optionally be contingent on certain restrictions such As minimum future activity or enrollment term. Other possible incentives include referral incentives whereby a customer is awarded equity in a company based on a determination that the customer enrolled a new program participant. Such referral incentives may also be contingent on similar restrictions.

According to another aspect of the invention, equity is awarded to customer accounts as fractional shares, by taking equity awards from enrolled customers over a period of time and purchasing equity in one larger aggregated buy, which is then distributed as fractional amounts to the customers. The awards can be based on direct investment orders from the customer or on customer transactions. As a result, transactional costs are reduced and fractional share amounts are available to program participants.

According to still another aspect of the invention, customers in the program may specify that equity proceeds are to be awarded to entities designated by the customer, such as to friends, family members, charitable institutions, and educational institutions, etc.

According to yet another aspect of the invention, equity and other incentives are awarded based on predetermined transactional levels, account positions and tenure in the program.

According to another aspect of the invention, customers in the program are able to shop using stock acquired in the program based on a specified market price.

According to still another aspect of the invention, customers in the program receive lower interest rates on credit transactions or a larger line of credit based on the customer's equity position.

According to still another aspect of the invention, customers will be able to use program credit cards to shop at merchant program members at the point of sale and receive rewards.

According to yet another aspect of the invention, customers in the program may designate that purchase amounts are to be rounded up from the actual transactional purchase price, with the difference being used to purchase equity. In this way, the program encourages growth of equity positions.

These and other aspects of the invention provide incentives for (customers to invest in a particular company (such as a merchant) and to remain as long term investors. The invention further provides a vehicle for the company to raise and manage capital and to collect customer data so as to more effectively market to a preferred group of customers and to identify potential customers with desired demographic characteristics and tendencies for marketing purposes.

### BRIEF DESCRIPTION OF THE FIGURES

FIG. 1 illustrates the exemplary components of a system for rewarding customers that is suitable for use with the present invention.

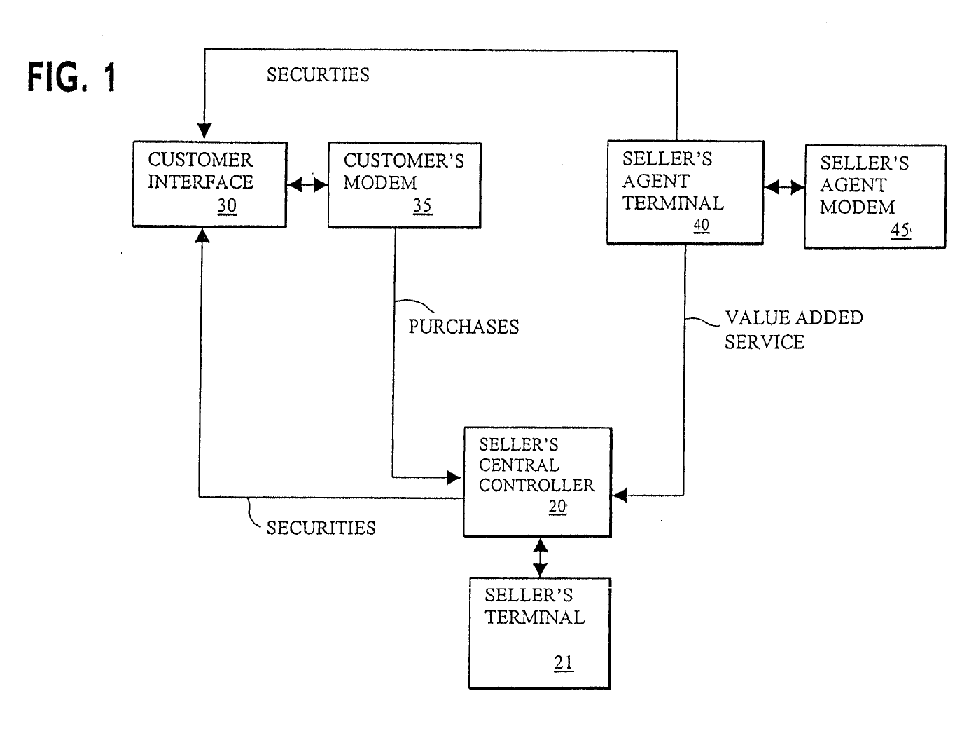

FIG. 2 is flowchart illustrating a feature according to the invention by which a customer designates other entities to receive awards.

FIG. 3 is a flowchart illustrating a feature according to the invention by which customers receive equity incentives for referrals.

FIG. 4 is a flowchart illustrating a feature according to the invention by which customers receive equity incentives for initially enrolling in the program.

FIG. 5 is a flowchart illustrating a feature according to the invention by which customers receive equity incentives for various levels determined by performance, tenure and account positions.

FIG. 6 is a flowchart illustrating a feature according to the invention by which customers shop at merchants affiliated with a program using stock the (customer has accumulated in the customer's account.

FIG. 7 is a flowchart illustrating a feature according to the invention by which customers leverage their equity position by earning lower interest rates or larger credit lines.

FIG. 8 is a flowchart illustrating a feature according to the invention by which a customer may designate transaction amounts to be rounded up by a predetermined amount, with the excess amount being designated for direct equity purchase.

### DETAILED DESCRIPTION OF THE PREFERRED EMBODIMENTS

The above-noted and other aspects of the present invention will become more apparent from a description embodiment of the invention, when read in conjunction with the accompanying drawings.

The present invention is based generally on an equity award system and method in which customer transactions with a particular company are rewarded in the form of equity in that company or an affiliated company. Such a system is generally described in the above-identified, commonly assigned patent applications. The following description describes certain enhancements and improvements.

General features of the system include: (1) targeting and enrolling customers; (2) calculating, offering and awarding incentives and other benefits; (3) profiling or “tiering” customers to identify preferred customers, particularly those who have an equity share in a particular company; and (4) calculating and awarding equity in a company with which the customer transacts business. According to one aspect of the invention, information used to profile customers is continuously maintained in the course of account administration. This profile is then used to determine award levels, provide other offers and incentives to maintain relationships with preferred customers, and to preferentially target and enroll other potential customers with desirable profiles.

In accordance with a feature of the invention, fractional shares are distributed into customer's accounts. This is accomplished by maintaining a record of all orders for particular equities. Such orders may be based on equity awards for customer transactions, or optionally, may also be based on direct investing. Direct investment requests may comprise direct investment orders or may result from “round up” purchases in accordance with the feature described herein.

Purchase order records are periodically processed. Processing includes verification that requested equities are available. It further includes aggregating the equity awards orders into larger lots that are then purchased in one or more buy transactions. The larger sized lots are then divided among the customer accounts from which the equity awards were taken. In this way orders may be processed without incurring relatively large transaction costs while allowing distribution of fractional amounts of equity shares.

According to another feature of the invention, customers may elect to invest in more than one merchant. By offering consumers multiple merchants at which to invest and shop through the program portal, the program is able to collect information on how the consumers invest and shop at multiple sites. By sampling and correlating the relationship of the consumer's shopping and investment decisions at multiple merchant sites, the program portal collects data that gives a unique view of customer loyalty. This enables identification of cross buying patterns among multiple merchants in a very high end category of consumers.

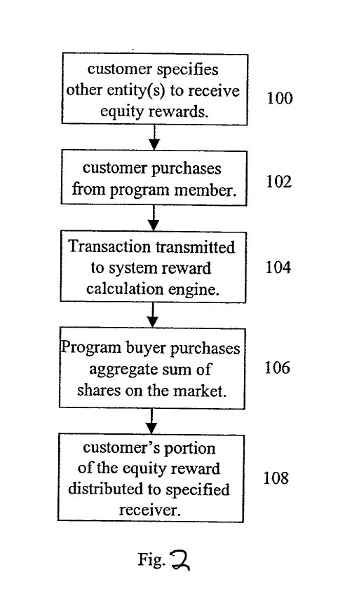

As illustrated in FIG. 2, according to another feature of the invention, customers of the program are able to specify through their account management system that equity proceeds from the program are given to friends, family members, charitable institutions, educational institutions, etc. (100). When a consumer makes a purchase from the program member (102), the program engine calculates the amount of the reward to be given as a result of the customers transaction level and possibly other factors (104). The amount of equity reward to be given is then aggregated with the other rewards of a specific time period. The program manager then makes a purchase of the aggregate amount on the market or directly from the company (106). Based on the calculation of the consumer's original reward, a certain amount of stock (a whole value or fractional value) is distributed to the entity that the consumer has specified to receive the stock (108). Subject to IRS rulings, there could be extra tax benefits to the donator based on the value of the equity, etc.

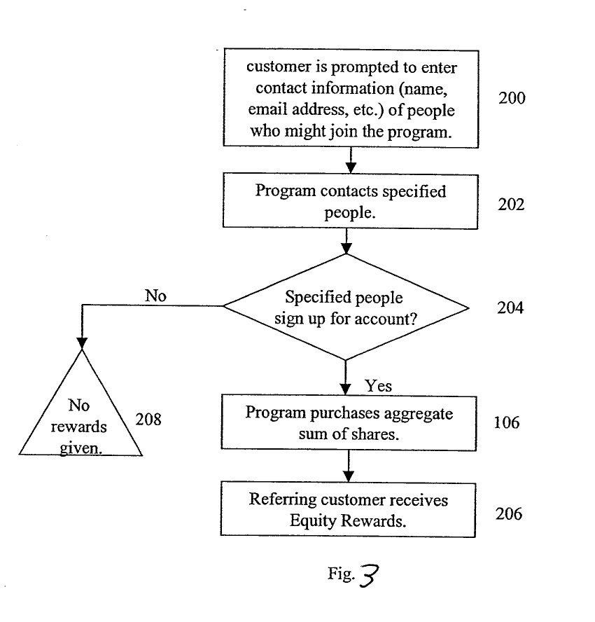

Another enrollment feature is illustrated in FIG. 3. Customers receive equity incentives for referring friends to their site who then sign up for the service. This is done by prompting the customer to enter the contact information of potentials clients (200). These potentials will be contacted and marketed to (202). If they enroll, the referring customer receives a bonus (206). Such bonus may comprise, for example, additional equity in a merchant already owned by the customer.

Other ways of identifying referrals are possible. For example, new customers may be asked to identify any referring customers.

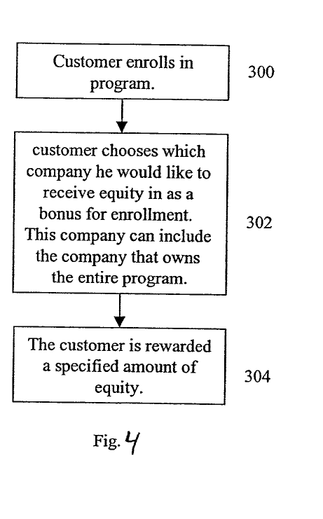

According to another feature of the invention shown in FIG. 4, customers receive equity incentives for initially enrolling in the program. A customer enrolls in the program (300), for example, through an on-line registration process or by completing a printed form. The customer's registration is processed and recorded in the program database. As part of this process, the customer selects which company he would like to receive equity in (302). The system rewards the customer with a predetermined amount of equity in the specified company (304).

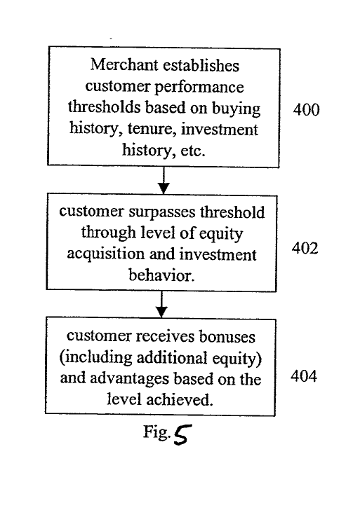

According to another feature of the invention shown in FIG. 5, customers receive equity incentives for achieving various levels in performance and tenure and account positions. Based on the customer's level of shopping and investing, they will be segregated into customer tiers. These tiers are determined by the merchant and possibly the program manager (400). As members of these tiers, the customers are entitled to various incentives which could include information, advanced purchase options, discounts, coupons, additional equity, etc. The program's goal is to incentivize customers to remain loyal to companies within the programs and to maintain long-term stable investment portfolios that they have built through direct investing and the equity rewards that they have received through the program. Customers will receive further rewards for moving into a higher tier (402, 404).

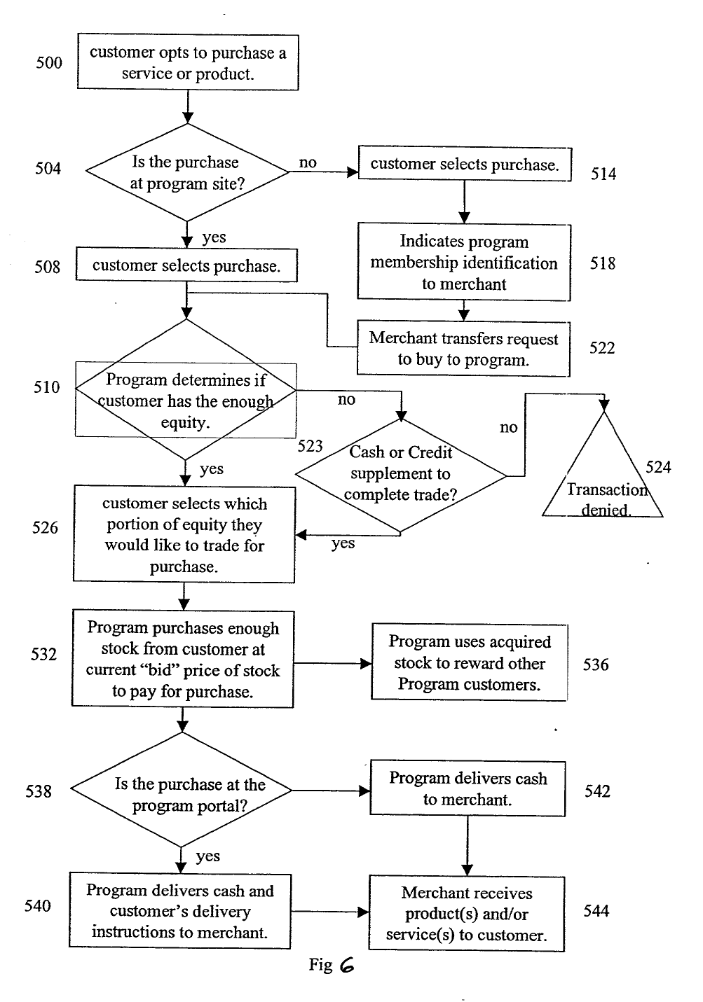

According to a feature of the invention shown in FIG. 6, customers are be able to shop with program merchants using the stock they have acquired based on a specified market price of the stock they hold (which may or may not be real-time market value). The program customer decides that he or she would like to purchase a product or service from a merchant who is also a member of the program (500). The customer is able to purchase the good or service through the program's portal (most likely the web site) or through the merchant's point of sale, which can include a web site, a kiosk, a physical store, telephonic means, etc (504).

If the customer decides to make the purchase through the program web site, the customer selects what he or she would like to purchase (508). The program's software then determines whether the value of the stock (based on the bid prices of the positions in the portfolio) is currently sufficient to make the purchase (510). If there is enough equity to cover the purchase, the program then prompts the customer to instruct the program as to which portion of his or her portfolio he or she would like to exchange in the purchase transaction (526). If the customer does not have enough to cover the purchase, a cash supplement is suggested (523). If the customer does not wish to make up the difference with cash or credit, the transaction is then terminated (524).

If the customer decides to make the purchase through the merchant's point of sale, the customer must indicate at “check-out” his or her program membership identification (518). This information and the request to make the trade for purchase is transmitted to the program's software and databases (522). If the program determines the customer is able to make the purchase, the program transmits back to the merchant that the customer is allowed to make the purchase (510). At this point the customer is able to select the portion of equity he or she would like to exchange (if the customer has not done this on a pre-elected basis) (526).

At this point the two pathways (merchant POS or program portal) converge. The program purchases enough equity from the customer at the bid price of the stock(s) (532). The program then delivers the funds to cover the transaction to the merchant as well as the delivery instructions from the customer if the purchase is made at the program portal (540).

The program then takes the newly acquired stock and delivers it to other customers in the program who are being rewarded for their purchases (536). The program may calculate the value to reward the customer based on the “ask” price of the stock. Consequently, the program may earn revenues by taking all or a portion of the spread between the “bid” and the “ask”.

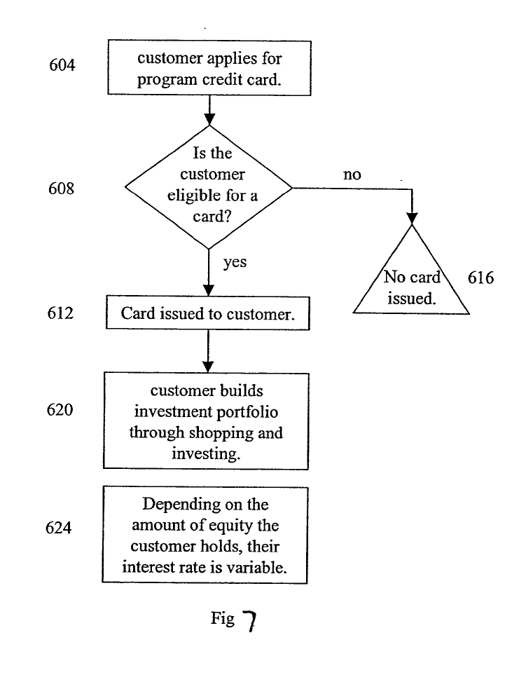

According to a feature illustrated in FIG. 7, customers will be able to leverage their equity positions to earn low interest loans on their credit cards based on the value of their portfolios. Larger portfolios may trigger lower rates or increase the credit available at a given rate. This encourages customers to maintain their positions for longer periods of time.

Customers earn equity through shopping and investing. Identified as an appropriate credit card holder by the program's credit worthiness standards, the customer is offered the opportunity to apply for a credit card. The customer applies for the card through the portal or possibly other means (mail, etc.). The customer is checked again to see if he or she is eligible for the card and, if so, what credit line is appropriate.

The customer's variable interest rate for the credit card is determined by the amount of equity he or she holds in the account. The more equity held, the lower the interest rate.

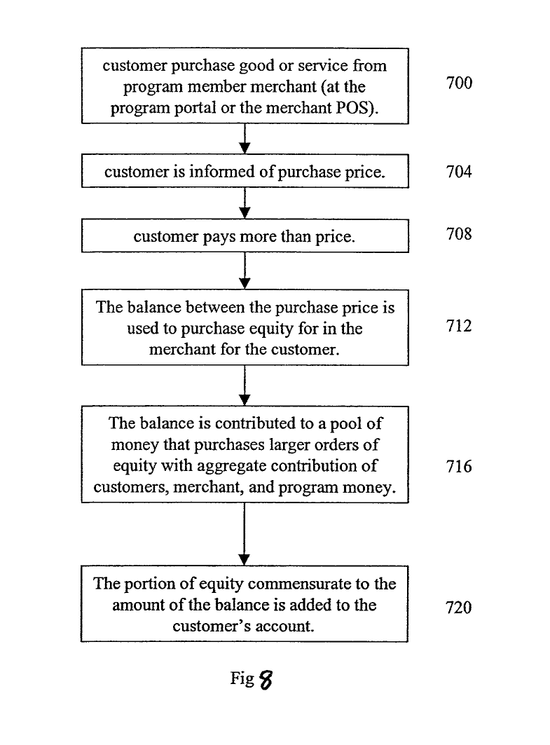

According to the feature illustrated in FIG. 8, customers may elect to “roundup” a transaction amount while shopping at the merchant sites in order to have the excess portion invested in a given company. For example, a customer purchase $123.50 worth of groceries at the store. The customer could round up her bill $0.50 and have the spare change put into a change fund which could later be invested. In another possible example, the customer rounds up to $150 and invests $26.50 into the company.

Another feature of the invention allows consumers to use a credit card tied into the program to shop at a merchant. The consumer will receive rewards based on purchases made with this card using its purchase transaction history. The credit card allows the consumer an option for shopping in an offline environment without having the program directly integrated into the point of sale.

The functionality disclosed herein can be implemented by hardware, software, and/or a combination of both. Software implementations can be written in any suitable language, including without limitation high-level programming languages such as C++, mid-level and low-level languages, assembly languages, and application-specific or device-specific languages. Such software can run on a general purpose computer such as a Pentium based system, an application specific piece of hardware, or other suitable device.

At least part of the functionality described herein may be embodied in computer readable media, such as magnetic, magneticoptical, and optical media, used in programming an information-processing apparatus to perform in accordance with the invention. This functionality also may be embodied in computer readable media.

It is contemplated that the functionality described herein is preferably implemented with a network associated with a program administrator that maintains customer records, manages and records customer transactions, and calculates and stores incentives and awards. Further, it is contemplated that the program network communicates with a merchant network to track point of sale transactions or “e-commerce” transactions that may take place on-line through Internet web sites or similar portals. Additionally, it is contemplated that the program network may communicate with a dedicated network that purchases and distributes equity awards, for example, through an internal stock purchase plan or though a brokerage network by which publicly traded securities are purchased.

The scope of the present invention is meant to be that set forth in the claims that follow and equivalents thereof, and is not limited to any of the specific embodiments described above.

What is claimed is:

1. A method of providing a customer incentive program comprising the steps of:
creating accounts for customers;
collecting information pertaining to purchasing transactions made by the customers with sellers using their respective accounts;
awarding equity interests in the sellers to the customers based at least in part on the collected information;
aggregating the equity awards into one or more aggregate blocks, the aggregate blocks including awards for different customer accounts; and
acquiring the equity for the equity awards based on the aggregate blocks.

2. A method as recited in claim 1, wherein the purchasing transactions include purchases of goods or services using the Internet.

3. A method as recited in claim 1, wherein the step of creating accounts is performed using the Internet.

4. A method as recited in claim 1, wherein the step of collecting information is performed using the Internet.

5. A method as recited in claim 1, wherein the step of awarding equity interests to the customers further comprises:
determining values associated with the purchasing transactions of each customer using his account; and
awarding an equity interest to each customer in an amount based on the value.

6. A method as recited in any of claim 2, wherein the step of awarding equity interests to the customers further comprises:
determining values associated with the purchasing transactions of each customer using his account; and
awarding an equity interest to each customer in an amount based on the value.

7. A method as recited in any of claim 3, wherein the step of awarding equity interests to the customers further comprises:
determining values associated with the purchasing transactions of each customer using his account; and
awarding an equity interest to each customer in an amount based on the value.

8. A method as recited in any of claim 4, wherein the step of awarding equity interests to the customers further comprises:
determining values associated with the purchasing transactions of each customer using his account; and
awarding an equity interest to each customer in an amount based on the value.

9. A system for providing a customer incentive program comprising:
means for creating accounts for customers;
means for collecting information pertaining to purchasing transactions made by the customers with sellers using their respective accounts;
means for awarding equity interests in the sellers to the customers based at least in part on the collected information;
means for aggregating the equity awards into one or more aggregate blocks, the aggregate blocks including awards for different customer accounts; and
means for acquiring the equity for the equity awards based on the aggregate blocks.

10. A system as recited in claim 9, wherein the purchasing transactions include purchases of goods or services using the Internet.
